(19) United States
(12) Patent Application Publication
(10) Pub. No.: US 2025/0163084 A1
(43) Pub. Date: May 22, 2025

(54) METHOD OF PREPARING ALKYL PHOSPHATE COMPOUND BASED ON MICRO-REACTION SYSTEM

(71) Applicants: Jiangxi Normal University, Nanchang (CN); Fudan University, Shanghai (CN)

(72) Inventors: Fener CHEN, Shanghai (CN); Xianjing ZHENG, Shanghai (CN); Chang LIU, Shanghai (CN); Yiqun TIAN, Shanghai (CN); Yajiao ZHANG, Shanghai (CN); Li WAN, Shanghai (CN); Chunxue PENG, Shanghai (CN); Songlin ZHENG, Shanghai (CN); Liangchuan LAI, Shanghai (CN)

(21) Appl. No.: 19/031,731

(22) Filed: Jan. 18, 2025

(30) Foreign Application Priority Data
Apr. 23, 2024 (CN) 202410488497.X

(51) Int. Cl. C07F 9/50; B01J 19/00; C07F 9/46

(52) U.S. Cl. CPC C07F 9/5004; B01J 19/0093; C07F 9/46; B01J 2219/0086; B01J 2219/00867; B01J 2219/00889

(57) ABSTRACT

A method of preparing an alkyl phosphate compound based on a micro-reaction system. The micro-reaction system includes a feed pump, a first micro-mixer, a second micro-mixer, a first micro-channel reactor, a second micro-channel reactor and a back-pressure device, where the first micro-mixer, the second micro-mixer, the first micro-channel reactor, the second micro-channel reactor and the back-pressure device are sequentially connected. The method includes the following steps. An alkylamine compound and an acid-binding agent are simultaneously fed to a first micro-mixer for mixing and then to the first micro-channel reactor for pre-reaction to obtain a pre-reaction solution. The pre-reaction solution and a phosphate or phosphite are simultaneously fed to the second micro-mixer for mixing to obtain a first reaction mixture. The first reaction mixture is fed to the second micro-channel reactor to carry out a condensation reaction under a back pressure condition and is concentrated to obtain the final product.

### CROSS-REFERENCE TO RELATED APPLICATIONS

This application claims the benefit of priority from Chinese Patent Application No. 202410488497.X, filed on Apr. 23, 2024. The content of the aforementioned application, including any intervening amendments thereto, is incorporated herein by reference in its entirety.

### TECHNICAL FIELD

This application relates to organic chemical synthesis, and more specifically to a method of preparing an alkyl phosphate compound based on a micro-reaction system.

### BACKGROUND

Alkyl phosphonates are a class of important organophosphorus compounds with broad application prospects in the fields of functional materials, pesticides, organophosphine ligands, and asymmetric catalysis. Some chiral phosphonates also show unique biological activities in the fields of life sciences and pharmaceuticals. The synthesis of alkyl phosphonates through the condensation reaction of alkyl amines with phosphoric acid esters and phosphites has advantages of mild reaction conditions and high selectivity. In contrast, the traditional method of synthesizing alkyl phosphonates mainly utilizes the Michaelis-Arbuzov rearrangement reaction between three-coordinated phosphites and haloalkanes to construct the P—C bond, so as to produce alkyl phosphonates, and then the target compounds with special structures are prepared by halogenation and esterification reactions. However, the classical Michaelis-Arbuzov rearrangement reaction, in which the trialkyl phosphite is used as the starting material, is not suitable for industrial synthesis due to deficiencies of high temperature, low selectivity, and poor functional group applicability.

Chinese Patent Publication No. CN102911203A discloses a method of preparing an alkyl phosphate ester, in which the alkyl alcohol is used as the raw material, and a phosphorylation reagent is added in batches to carry out the phosphorylation reaction, and finally deionized water is added to carry out the hydrolysis reaction to obtain fatty alcohol polyoxyethylene ether phosphate ester. Although the synthesized product has high selectivity, the reactions involved in this method are carried out in a traditional kettle, which has a low production efficiency and is time-consuming. Chinese Patent Publication No. CN102603792A discloses a method of preparing tetraalkyl diphosphates, in which the tetrachloro diphosphate and an alcohol are reacted and neutralized with a base to obtain hydrogen chloride, and the salt formed in the neutralization action is separated from the reaction mixture as a concentrated aqueous solution. The product purification requires the addition of water to take advantage of the difference in solubility, which can lead to a lot of products dissolved in water resulting in a lower yield, and generates a large amount of wastewater containing organic matter. Thus, this method poses serious pollution and is unsuitable for industrial application. Chinees Patent Publication CN114832752 A disclosed a method and device for continuous synthesis of alkyl phosphate using a microchannel reactor, in which the phosphate, solid phosphorus pentoxide, catalyst and ethylene oxide are added in proportion to a microchannel reactor for reaction. However, a large number of the catalyst is required, and the raw material used is the solid phosphorus pentoxide. For the microchannel reaction, the solid raw material is difficult for feeding, which seriously affects the condensation reaction. Therefore, it is not suitable for industrialized production.

### SUMMARY

An objective of the present disclosure is to provide a method of preparing an alkyl phosphate compound based on a micro-reaction system to overcome the problems in the prior art

A method of preparing an alkyl phosphate compound based on a micro-reaction system, the micro-reaction system comprising a feed pump, a first micro-mixer, a second micro-mixer, a first micro-channel reactor, a second micro-channel reactor and a back-pressure device; the first micro-mixer, the second micro-mixer, the first micro-channel reactor, the second micro-channel reactor and the back-pressure device being sequentially connected; and the method comprising:
(1) simultaneously feeding a first organic solution containing an alkylamine compound of formula (I) and a second organic solution containing an acid-binding agent to a first micro-mixer for mixing and then entering the first micro-channel reactor for pre-reaction to obtain a pre-reaction solution;
(2) simultaneously feeding the pre-reaction solution and a second organic solution containing a phosphate of formula (II) or a phosphite of formula (III) to the second micro-mixer for mixing to obtain a first reaction mixture;
(3) feeding the first reaction mixture to the second micro-channel reactor to carry out a condensation reaction under a back pressure condition set by the back pressure device to obtain a second reaction mixture;
(4) collecting the second reaction mixture by a storage tank for concentration to obtain an alkyl phosphate ester compound of formula (IV) or formula (V);

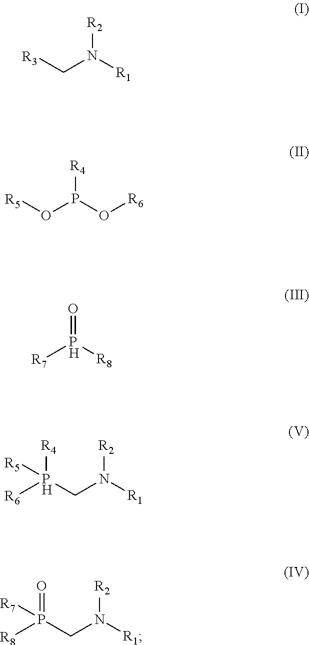

wherein R1 is selected from the group consisting of hydrogen, a C₁-C₁₂ alkyl, —COOH, —CH₂COOH, and a C₂-C₁₂ alkylcarboxylic acid; R₂ is selected from the group consisting of hydrogen, a C₁-C₁₂ alkyl, and a C₃-C₆ cycloalkyl; R₃ is selected from the group consisting of hydrogen, —OCH₃, —OCH₂CH₃, a C₂-C₁₂ alkoxy, trifluoromethyl, trifluoromethoxy, and 2-oxocyclopentylidenemethylidene; R₄ is selected from the group consisting of hydrogen, carbonyl, a C₁-C₁₂ alkyl, and a C₃-C₆ cycloalkyl; R₅ and R₆ are each selected from the group consisting of hydrogen, a C₁-C₁₂ alkyl, a C₃-C₆ cycloalkyl, and a C₂-C₁₂ alkoxy; and R₇ and R₈ are each selected from the group consisting of hydrogen, —OCH₃, —OCH₂CH₃, a C₂-C₁₂ alkoxy, trifluoromethyl, trifluoromethoxy, and 2-oxocyclopentylidene.

In an embodiment, in step (1), the acid-binding agent is selected from the group consisting of triethylamine, tributylamine, trimethylamine, diisopropylethylamine (DIPEA), lithium formate, sodium formate, potassium formate, ammonium formate, R₂COOLi, R₂COONa, R₂COOK, R₂COONH₄, pyridine, and 2,6-dimethylpyridine.

Preferably, the acid-binding agent is selected from the group consisting of triethylamine, trimethylamine, tributylamine, diethylamine, DIPEA, p-dimethylaminopyridine, pyridine, N, N-diisopropylethylamine, and a combination thereof.

In an embodiment, in step (1), the organic solvent is selected from pentanol, butanol, isobutanol, tert-butanol, propanol, isopropanol, ethanol, methanol, methyl tert-butyl ether, tetrahydrofuran, 2-methyltetrahydrofuran, acetone, butanone, and methyl isobutyl ketone. Preferably, the organic solvent is selected from the group consisting of pentanol, butanol, isobutanol, tert-butanol, propanol, isopropanol, ethanol, methanol, acetone, butanone and a combination thereof. More preferably, the organic solvent is selected from the group consisting of butanol, propanol, isopropanol, ethanol, methanol and a combination thereof.

In an embodiment, the pre-reaction in the first micro-channel reactor is performed at 30-60° C. for 2-15 min; and the condensation reaction in the second micro-channel reactor is performed at 40-100° C. for 5-20 min. Preferably, the pre-reaction in the first micro-channel reactor is performed at 30-50° C. for 2-10 min; and the condensation reaction in the second micro-channel reactor is performed at 40-100° C. for 5-15 min.

In an embodiment, a back pressure of the back pressure device is 10-100 bar, preferably, 10-50 bar.

In an embodiment, the first micro-mixer and second micro-mixer are each selected from a T-type micro-mixer, a Y-type micro-mixer, a Z-type micro-mixer, an X-type micro-mixer, a SK-type micro-mixer, a SX-type micro-mixer, a SV-type micro-mixer, and a serpentine plate-type micro-mixer. Preferably, the first micro-mixer and second micro-mixer are each selected from a Y-type micro-mixer, an X-type micro-mixer, a SK-type micro-mixer, a SX-type micro-mixer, a SV-type micro-mixer, a serpentine plate-type micro-mixer, and a combination thereof.

In an embodiment, the serpentine plate type micro-mixer is provided with a channel; a serpentine (or wavelike) pipeline is provided in the channel; angular projections are staggeredly provided in the serpentine pipeline; one end of the serpentine pipeline is provided with a feeding port, and the other end of the serpentine (or wavelike) pipeline is provided with a discharging port; a circulating liquid channel is provided between an outer side of the serpentine (or wavelike) pipeline and a wall of the channel; and one end of the circulating liquid channel is provided with a circulating liquid outlet, and the other end of the circulating liquid channel is provided with a circulating liquid inlet, as shown in FIG. 2.

In an embodiment, the first micro-mixer and the second micro-mixer are each provided with an inlet, an outlet and a mixing chamber; a diameter of the inlet and the outlet is 1.0 mm-6.0 mm; a diameter of the mixing chamber is 1.0 mm-20 mm; and a height of the mixing chamber is 1.0 mm-40 mm. Preferably, the diameter of the inlet and the outlet is 1.0 mm-5.0 mm; a diameter of the mixing chamber is 1.0 mm-15 mm; and a height of the mixing chamber is 1.0 mm-20 mm.

In an embodiment, the first micro-channel reactor and the second micro-channel reactor are each a tubular micro-channel reactor with a water droplet configuration; the tubular micro-channel reactor is provided with a microchannel arranged in a plurality of S-shaped rows; and water droplet (or spherical) components are uniformly provided on an inner wall of the microchannel to ensure homogeneous mixing of reactants and sufficient reaction to provide a better reaction efficiency. One end of the microchannel is provided with a feeding port, and the other end of the microchannel is provided with a discharging port; an outer layer of the microchannel is configured as a circulating liquid channel for circulation a circulating liquid; and one end of the circulating liquid channel is provided with a circulating liquid outlet, and the other end of the circulating liquid channel is provided with a circulating liquid inlet. As shown in FIG. 3, the circulating fluid channel is a heat transfer fluid channel.

In an embodiment, an inner diameter of the microchannel is 0.1-50 mm, and a length of the microchannel is 10-100 m. Preferably, the inner diameter of the microchannel is 0.1-40 mm, and the length of the microchannel is 10-50 m.

In the present disclosure, the microchannel reactor is made of PTFE, polyvinylidene fluoride, stainless steel, hastelloy, zirconium, tantalum, nickel, silicon carbide, or glass. Preferably, the microchannel reactor is made of PTFE, stainless steel, hastelloy, silicon carbide, glass, or a combination thereof.

Compared with the prior art, the present disclosure has at least the following advantages.

The present disclosure employs a micro-reaction system comprising sequentially connected a micro-mixer, a micro-channel reactor, and a back-pressure device to carry out the condensation reaction of alkyl amine with phosphate ester and phosphite ester in the micro-channel reactor to prepare alkyl phosphate ester compounds. Compared with the traditional synthesis method, the method provided herein has at least the following advantages.

(1) The micro-mixer can greatly enhance the mass transfer effect of the multiphase system, improve the reaction rate while reducing the reactor volume. In the meanwhile, the micro-channel reactor has excellent mass transfer, heat transfer and material continuous mixing enhancement performance, which can effectively shorten the reaction time, improve the reaction efficiency and flux per unit volume of the reactor, leading to a higher reaction safety. The preparation of alkyl phosphate esters can be completed in minutes instead of 5-10 h by using traditional batch kettle reaction.

(2) Reactions involved in the method are carried out under the closed system throughout the whole process, which solves the problem of solvent volatilization and pollution, is safe and green, reduces the production cost, improves the revenue, and effectively reduces the three wastes.

(3) The use of the microchannel reaction system for the synthesis of alkyl phosphate ester compounds significantly reduces the number of operating workers and labor intensity, and significantly reduces production costs. The raw material conversion rate is above 99%, the purity is greater than 99%, and the total yield is greater than 89%.

(4) The use of a microchannel reactor enables convenient industrial production of the synthetic method of the present disclosure through a multi-channel parallel scale-up or size scale-up strategy.

### BRIEF DESCRIPTION OF THE DRAWINGS

FIG. 1 is a block diagram of a structure of a micro-reaction system according to an embodiment of the present disclosure;

FIG. 2 is a schematic diagram of a structure of a serpentine plate-type micro-mixer according to an embodiment of the present disclosure; and

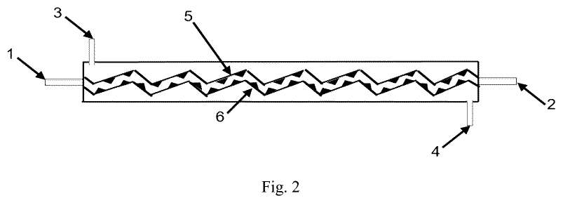

FIG. 3 is a schematic diagram of a structure of a tubular microchannel reactor with water droplet configuration according to an embodiment of the present disclosure.

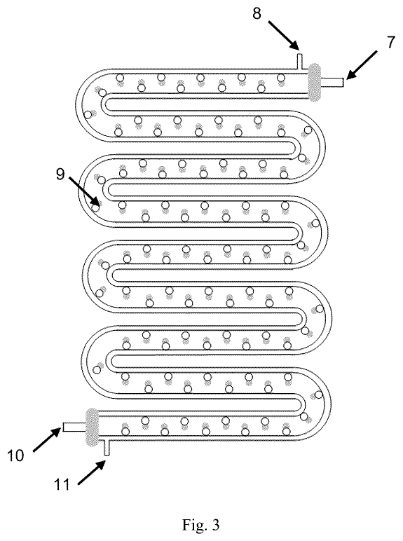

In the drawings:

1, feeding port; 2, discharging port; 3, circulating fluid outlet; 4, circulating fluid inlet; 5, serpentine micro-channel mixer; 6, projection; 7, inlet; 8, circulating fluid outlet; 9, water droplet component; 10, outlet; and 11, circulating fluid inlet.

### DETAILED DESCRIPTION OF EMBODIMENTS

The present disclosure will be described in further detail below with reference to embodiments.

### Example 1

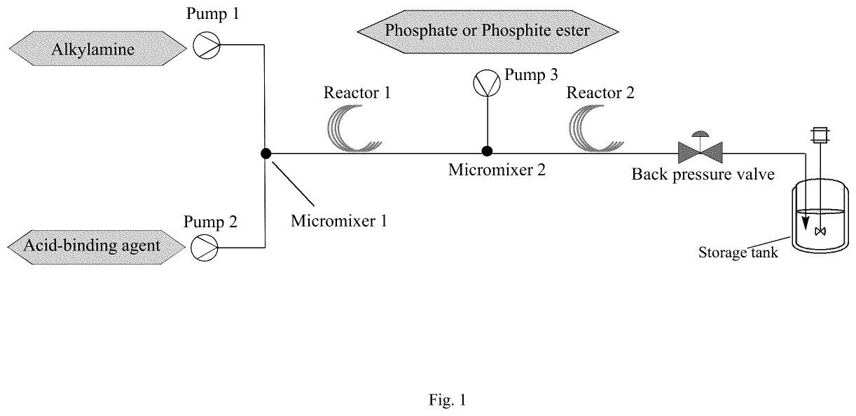

Provided herein was a method of condensation of an alkyl amine with a phosphate and a phosphite ester using a micro-reaction system. The micro-reaction system was as shown in FIG. 1. A methanol solution of alkyl compound of formula (I) with R₁ as —CH₂COOH, R₂ as CH₃, R₃ as —OCH₂CH₃ was pumped into a Y-type micro-mixer 1 through a plunger pump 1, and an acid-binding agent (triethylamine) was simultaneously pumped into the Y-type micro-mixer 1 through a pump 2 for mixing to obtain a mixture solution. The mixture solution was fed to a tubular microchannel reactor 1 for pre-reaction at 45° C. for 5 min to obtain a pre-reaction solution. The pre-reaction solution and a methanol solution of phosphate of formula (II) with R₄ as hydrogen, R₅ as —OCH₃, and R₆ as —OCH₂CH₃ were simultaneously pumped into the Y-type micro-mixer 2 through a pump 3 for mixing to obtain a reaction mixture. The reaction mixture was fed to a tubular micro-channel reactor 2 for condensation reaction at 80° C. and 20 bar for 8 min, and the reaction solution was concentrated to obtain an alkyl phosphate ester of formula (IV) with a one-way feedstock conversion of 80%, a yield of 78%, and a product quality purity of 99.1%.

### Example 2

Provided herein was a method of condensation of an alkyl amine with a phosphate and a phosphite ester using a micro-reaction system. The micro-reaction system was as shown in FIG. 1. A methanol solution of alkyl compound of formula (I) with R₁ as —CH₂COOH, R₂ as CH₃, R₃ as —OCH₂CH₃ was pumped into an X-type micro-mixer 1 through a plunger pump 1, and an acid-binding agent (triethylamine) was simultaneously pumped into the X-type micro-mixer 1 through a pump 2 for mixing to obtain a mixture solution. The mixture solution was fed to a tubular microchannel reactor 1 for pre-reaction at 45° C. for 5 min to obtain a pre-reaction solution. The pre-reaction solution and a methanolic solution of phosphate of formula (II) with R₄ as hydrogen, R₅ as —OCH₃, and R₆ as —OCH₂CH₃ were simultaneously pumped into the X-type micro-mixer 2 through a pump 3 for mixing to obtain a reaction mixture. The reaction mixture was fed to a tubular micro-channel reactor 2 for condensation reaction at 80° C. and 20 bar for 8 min, and the reaction solution was concentrated to obtain an alkyl phosphate ester of formula (IV) with a one-way feedstock conversion of 84%, a yield of 80%, and a product quality purity of 99.2%.

### Example 3

Provided herein was a method of condensation of an alkyl amine with a phosphate and a phosphite ester using a micro-reaction system. The micro-reaction system was as shown in FIG. 1. A methanol solution of alkyl compound of formula (I) with R₁ as —CH₂COOH, R₂ as CH₃, R₃ as —OCH₂CH₃ was pumped into an SV-type micro-mixer 1 through a plunger pump 1, and an acid-binding agent (triethylamine) was simultaneously pumped into the SV-type micro-mixer 1 through a pump 2 for mixing to obtain a mixture solution. The mixture solution was fed to a tubular microchannel reactor 1 for pre-reaction at 45° C. for 5 min to obtain a pre-reaction solution. The pre-reaction solution and a methanolic solution of phosphate of formula (II) with R₄ as hydrogen, R₅ as —OCH₃, and R₆ as —OCH₂CH₃ were simultaneously pumped into the SV-type micro-mixer 2 through a pump 3 for mixing to obtain a reaction mixture. The reaction mixture was fed to a tubular micro-channel reactor 2 for condensation reaction at 80° C. and 20 bar for 8 min, and the reaction solution was concentrated to obtain an alkyl phosphate ester of formula (IV) with a one-way feedstock conversion of 85%, a yield of 81.5%, and a product quality purity of 99.0%.

### Example 4

Provided herein was a method of condensation of an alkyl amine with a phosphate and a phosphite ester using a micro-reaction system. The micro-reaction system was as shown in FIG. 1. A methanol solution of alkyl compound of formula (I) with R₁ as —CH₂COOH, R₂ as CH₃, R₃ as —OCH₂CH₃ was pumped into a first serpentine plate-type micro-mixer 1 through a plunger pump 1, and an acid-binding agent (triethylamine) was simultaneously pumped into the first serpentine plate-type 1 through a pump 2 for mixing to obtain a mixture solution. The first serpentine plate micro-mixer 1 had a serpentine channel. The serpentine channel had a square cross section with a side length of 800 μm. A folding angle of the serpentine channel was 120°, and the distance between the former folding angle and the latter folding angle was 10 mm. Two equilateral triangles with a side length of 300 μm were provided on the channel wall at the 10 mm spacing, and two equilateral triangles with a side length of 300 μm were likewise provided on the opposing channel wall, which was used for enhancing the fluid mixing efficiency. The mixture solution was fed to a tubular microchannel reactor 1 for pre-reaction at 45° C. for 5 min to obtain a pre-reaction solution. The pre-reaction solution and a methanolic solution of phosphate of formula (II) with R₄ as hydrogen, R₅ as —OCH₃, and R₆ as —OCH₂CH₃ were simultaneously pumped into the serpentine-type micro-mixer 2 through a pump 3 for mixing to obtain a reaction mixture. The reaction mixture was fed to a tubular micro-channel reactor 2 for condensation reaction at 80° C. and 20 bar for 8 min, and the reaction solution was concentrated to obtain an alkyl phosphate ester of formula (IV) with a one-way feedstock conversion of 94%, a yield of 91.5%, and a product quality purity of 99.4%.

### Example 5

Provided herein was a method of condensation of an alkyl amine with a phosphate and a phosphite ester using a micro-reaction system. The micro-reaction system was as shown in FIG. 1. A methanol solution of alkyl compound of formula (I) with R₁ as —CH₂COOH, R₂ as CH₃, R₃ as —OCH₂CH₃ was pumped into a first serpentine plate-type micro-mixer 1 through a plunger pump 1, and an acid-binding agent (triethylamine) was simultaneously pumped into the first serpentine plate-type 1 through a pump 2 for mixing to obtain a mixture solution. The mixture solution was fed to a tubular microchannel reactor 1 with water droplet configuration for pre-reaction at 45° C. for 5 min to obtain a pre-reaction solution, where an inner diameter of an inlet and an outlet of the channel of the tubular microchannel reactor 1 was 1.6 mm, and balls with a diameter of 500 μm were placed on the channel wall every 10 mm to enhance fluid mixing. The pre-reaction solution and a methanol solution of phosphate of formula (II) with R₄ as hydrogen, R₅ as —OCH₃, and R₆ as —OCH₂CH₃ were simultaneously pumped into a second serpentine-type micro-mixer 2 through a pump 3 for mixing to obtain a reaction mixture. The reaction mixture was fed to a second tubular micro-channel reactor 2 with water droplet configuration for condensation reaction at 80° C. and 20 bar for 8 min, and the reaction solution was concentrated to obtain an alkyl phosphate ester of formula (IV) with a one-way feedstock conversion of 98%, a yield of 95%, and a product quality purity of 99.6%.

### Example 6

Provided herein was a method of condensation of an alkyl amine with a phosphate and a phosphite ester using a micro-reaction system. The micro-reaction system was as shown in FIG. 1. A methanol solution of alkyl compound of formula (I) with R₁ as —CH₂COOH, R₂ as hydrogen, R₃ as —OCH₂CH₃ was pumped into a first serpentine plate-type micro-mixer 1 through a plunger pump 1, and an acid-binding agent (triethylamine) was simultaneously pumped into the first serpentine plate-type 1 through a pump 2 for mixing to obtain a mixture solution. The mixture solution was fed to a first tubular microchannel reactor 1 with water droplet configuration for pre-reaction at 45° C. for 2 min to obtain a pre-reaction solution. The pre-reaction solution and a methanol solution of phosphate of formula (II) with R₄ as CH₃, R₅ as —OCH₃, and R₆ as —OCH₂CH₃ were simultaneously pumped into a second serpentine-type micro-mixer 2 through a pump 3 for mixing to obtain a reaction mixture. The reaction mixture was fed to a second tubular micro-channel reactor 2 with water droplet configuration for condensation reaction at 55° C. and 20 bar for 8 min, and the reaction solution was concentrated to obtain an alkyl phosphate ester of formula (IV) with a one-way feedstock conversion of 98%, a yield of 96%, and a product quality purity of 99.3%.

### Example 7

Provided herein was a method of condensation of an alkyl amine with a phosphate and a phosphite ester using a micro-reaction system. The micro-reaction system was as shown in FIG. 1. A methanol solution of alkyl compound of formula (I) with R₁ as COOH, R₂ as hydrogen, R₃ as —OCH₂CH₃ was pumped into a first serpentine plate-type micro-mixer 1 through a plunger pump 1, and an acid-binding agent (triethylamine) was simultaneously pumped into the first serpentine plate-type 1 through a pump 2 for mixing to obtain a mixture solution. The mixture solution was fed to a first tubular microchannel reactor 1 with water droplet configuration for pre-reaction at 45° C. for 2 min to obtain a pre-reaction solution. The pre-reaction solution and a methanolic solution of phosphite ester of formula (III) with R₇ as —OCH₃, and R₈ as —OCH₂CH₃ were simultaneously pumped into a second serpentine-type micro-mixer 2 through a pump 3 for mixing to obtain a reaction mixture. The reaction mixture was fed to a second tubular micro-channel reactor 2 with water droplet configuration for condensation reaction at 55° C. and 20 bar for 8 min, and the reaction solution was concentrated to obtain an alkyl phosphate ester of formula (V) with a one-way feedstock conversion of 96%, a yield of 94.5%, and a product quality purity of 99.7%.

### Example 8

Provided herein was a method of condensation of an alkyl amine with a phosphate and a phosphite ester using a micro-reaction system. The micro-reaction system was as shown in FIG. 1. A methanol solution of alkyl compound of formula (I) with R₁ as —COOH, R₂ as CH₃, R₃ as —OCH₂CH₃ was pumped into a first serpentine plate-type micro-mixer 1 through a plunger pump 1, and an acid-binding agent (trimethylamine) was simultaneously pumped into the first serpentine plate-type 1 through a pump 2 for mixing to obtain a mixture solution. The mixture solution was fed to a first tubular microchannel reactor 1 with water droplet configuration for pre-reaction at 50° C. for 5 min to obtain a pre-reaction solution. The pre-reaction solution and a methanolic solution of phosphate of formula (II) with R₄ as —CH₃, R₅ as —OCH₃, and R₆ as —OCH₂CH₃ were simultaneously pumped into a second serpentine-type micro-mixer 2 through a pump 3 for mixing to obtain a reaction mixture. The reaction mixture was fed to a second tubular micro-channel reactor 2 with water droplet configuration for condensation reaction at 70° C. and 25 bar for 10 min, and the reaction solution was concentrated to obtain an alkyl phosphate ester of formula (IV) with a one-way feedstock conversion of 97%, a yield of 95%, and a product quality purity of 99.1%.

### Example 9

Provided herein was a method of condensation of an alkyl amine with a phosphate and a phosphite ester using a micro-reaction system. The micro-reaction system was as shown in FIG. 1. A methanol solution of alkyl compound of formula (I) with R₁ as —CH₂COOH, R₂ as CH₃, R₃ as —OCH₂CH₃ was pumped into a first serpentine plate-type micro-mixer 1 through a plunger pump 1, and an acid-binding agent (triethylamine) was simultaneously pumped into the first serpentine plate-type 1 through a pump 2 for mixing to obtain a mixture solution. The mixture solution was fed to a first tubular microchannel reactor 1 with water droplet configuration for pre-reaction at 45° C. for 5 min to obtain a pre-reaction solution. The pre-reaction solution and a methanolic solution of phosphate of formula (II) with R₄ as hydrogen, R₅ as —OCH₃, and R₆ as —OCH₃ were simultaneously pumped into a second serpentine-type micro-mixer 2 through a pump 3 for mixing to obtain a reaction mixture. The reaction mixture was fed to a second tubular micro-channel reactor 2 with water droplet configuration for condensation reaction at 80° C. and 20 bar for 8 min, and the reaction solution was concentrated to obtain an alkyl phosphate ester of formula (IV) with a one-way feedstock conversion of 98%, a yield of 95.8%, and a product quality purity of 99.6%.

### Example 10

Provided herein was a method of condensation of an alkyl amine with a phosphate and a phosphite ester using a micro-reaction system. The micro-reaction system was as shown in FIG. 1. A methanol solution of alkyl compound of formula (I) with R₁ as —CH₂COOH, R₂ as CH₃, R₃ as —OCH₂CH₃ was pumped into a first serpentine plate-type micro-mixer 1 through a plunger pump 1, and an acid-binding agent (tributylamine) was simultaneously pumped into the first serpentine plate-type 1 through a pump 2 for mixing to obtain a mixture solution. The mixture solution was fed to a first tubular microchannel reactor 1 with water droplet configuration for pre-reaction at 35° C. for 5 min to obtain a pre-reaction solution. The pre-reaction solution and a methanolic solution of phosphate of formula (II) with R₄ as hydrogen, R₅ as —OCH₃, and R₆ as —OCH₂CH₃ were simultaneously pumped into a second serpentine-type micro-mixer 2 through a pump 3 for mixing to obtain a reaction mixture. The reaction mixture was fed to a second tubular micro-channel reactor 2 with water droplet configuration for condensation reaction at 70° C. and 28 bar for 7 min, and the reaction solution was concentrated to obtain an alkyl phosphate ester of formula (IV) with a one-way feedstock conversion of 97%, a yield of 95%, and a product quality purity of 99.0%.

### Example 11

Provided herein was a method of condensation of an alkyl amine with a phosphate and a phosphite ester using a micro-reaction system. The micro-reaction system was as shown in FIG. 1. An isopropanol solution of alkyl compound of formula (I) with R₁ as —CH₂COOH, R₂ as CH₃, R₃ as —OCH₂CH₃ was pumped into a first serpentine plate-type micro-mixer 1 through a plunger pump 1, and an acid-binding agent (triethylamine) was simultaneously pumped into the first serpentine plate-type 1 through a pump 2 for mixing to obtain a mixture solution. The mixture solution was fed to a first tubular microchannel reactor 1 with water droplet configuration for pre-reaction at 45° C. for 5 min to obtain a pre-reaction solution. The pre-reaction solution and an isopropanol solution of phosphate of formula (II) with R₄ as —CH₂CH₃, R₅ as —OCH₃, and R₆ as —OCH₃ were simultaneously pumped into a second serpentine-type micro-mixer 2 through a pump 3 for mixing to obtain a reaction mixture. The reaction mixture was fed to a second tubular micro-channel reactor 2 with water droplet configuration for condensation reaction at 80° C. and 35 bar for 10 min, and the reaction solution was concentrated to obtain an alkyl phosphate ester of formula (IV) with a one-way feedstock conversion of 95%, a yield of 93.8%, and a product quality purity of 99.2%.

### Example 12

Provided herein was a method of condensation of an alkyl amine with a phosphate and a phosphite ester using a micro-reaction system. The micro-reaction system was as shown in FIG. 1. An ethanol solution of alkyl compound of formula (I) with R₁ as —CH₂COOH, R₂ as CH₃, R₃ as —OCH₂CH₃ was pumped into a first serpentine plate-type micro-mixer 1 through a plunger pump 1, and an acid-binding agent (triethylamine) was simultaneously pumped into the first serpentine plate-type 1 through a pump 2 for mixing to obtain a mixture solution. The mixture solution was fed to a first tubular microchannel reactor 1 with water droplet configuration for pre-reaction at 40° C. for 8 min to obtain a pre-reaction solution. The pre-reaction solution and an ethanol solution of phosphite ester of formula (III) with R₇ as —OCH₃, and R₈ as —OCH₂CH₃ were simultaneously pumped into a second serpentine-type micro-mixer 2 through a pump 3 for mixing to obtain a reaction mixture. The reaction mixture was fed to a second tubular micro-channel reactor 2 with water droplet configuration for condensation reaction at 65° C. and 30 bar for 15 min, and the reaction solution was concentrated to obtain an alkyl phosphate ester of formula (V) with a one-way feedstock conversion of 96%, a yield of 94.8%, and a product quality purity of 99.8%.

### Example 13

Provided herein was a method of condensation of an alkyl amine with a phosphate and a phosphite ester using a micro-reaction system. The micro-reaction system was as shown in FIG. 1. An ethanol solution of alkyl compound of formula (I) with R₁ as —CH₂COOH, R₂ as CH₃, R₃ as —OCH₂CH₃ was pumped into a first serpentine plate-type micro-mixer 1 through a plunger pump 1, and an acid-binding agent (triethylamine) was simultaneously pumped into the first serpentine plate-type 1 through a pump 2 for mixing to obtain a mixture solution. The mixture solution was fed to a first tubular microchannel reactor 1 with water droplet configuration for pre-reaction at 40° C. for 8 min to obtain a pre-reaction solution. The pre-reaction solution and an ethanol solution of phosphite ester of formula (III) with R₇ as —OCH₂CH₃, and R₈ as —OCH₂CH₃ were simultaneously pumped into a second serpentine-type micro-mixer 2 through a pump 3 for mixing to obtain a reaction mixture. The reaction mixture was fed to a second tubular micro-channel reactor 2 with water droplet configuration for condensation reaction at 65° C. and 30 bar for 12 min, and the reaction solution was concentrated to obtain an alkyl phosphate ester of formula (V) with a one-way feedstock conversion of 97%, a yield of 96.2%, and a product quality purity of 99.1%.

### Example 14

Provided herein was a method of condensation of an alkyl amine with a phosphate and a phosphite ester using a micro-reaction system. The micro-reaction system was as shown in FIG. 1. An ethanol solution of alkyl compound of formula (I) with R₁ as —COOH, R₂ as CH₂CH₃, R₃ as —OCH₂CH₃ was pumped into a first serpentine plate-type micro-mixer 1 through a plunger pump 1, and an acid-binding agent (triethylamine) was simultaneously pumped into the first serpentine plate-type 1 through a pump 2 for mixing to obtain a mixture solution. The mixture solution was fed to a first tubular microchannel reactor 1 with water droplet configuration for pre-reaction at 40° C. for 8 min to obtain a pre-reaction solution. The pre-reaction solution and an ethanol solution of phosphite ester of formula (III) with R₇ as —OCH₂CH₃, and R₈ as hydrogen were simultaneously pumped into a second serpentine-type micro-mixer 2 through a pump 3 for mixing to obtain a reaction mixture. The reaction mixture was fed to a second tubular micro-channel reactor 2 with water droplet configuration for condensation reaction at 65° C. and 30 bar for 12 min, and the reaction solution was concentrated to obtain an alkyl phosphate ester of formula (V) with a one-way feedstock conversion of 98%, a yield of 95.2%, and a product quality purity of 99.8%.

### Example 15

Provided herein was a method of condensation of an alkyl amine with a phosphate and a phosphite ester using a micro-reaction system. The micro-reaction system was as shown in FIG. 1. A methanol solution of alkyl compound of formula (I) with R₁ as —CH₂COOH, R₂ as CH₃, R₃ as —OCH₂CH₃ was pumped into a first serpentine plate-type micro-mixer 1 through a plunger pump 1, and an acid-binding agent (triethylamine) was simultaneously pumped into the first serpentine plate-type 1 through a pump 2 for mixing to obtain a mixture solution. The mixture solution was fed to a first tubular microchannel reactor 1 with water droplet configuration for pre-reaction at 45° C. for 5 min to obtain a pre-reaction solution. The pre-reaction solution and a methanolic solution of phosphate of formula (II) with R₄ as carbonyl, R₅ as —OCH₃, and R₆ as —OCH₃ were simultaneously pumped into a second serpentine-type micro-mixer 2 through a pump 3 for mixing to obtain a reaction mixture. The reaction mixture was fed to a second tubular micro-channel reactor 2 with water droplet configuration for condensation reaction at 80° C. and 20 bar for 8 min, and the reaction solution was concentrated to obtain an alkyl phosphate ester of formula (IV) with a one-way feedstock conversion of 99%, a yield of 97.8%, and a product quality purity of 99.3%.

What is claimed is:

1. A method of preparing an alkyl phosphate compound based on a micro-reaction system, the micro-reaction system comprising a feed pump, a first micro-mixer, a second micro-mixer, a first micro-channel reactor, a second micro-channel reactor and a back-pressure device; the first micro-mixer, the second micro-mixer, the first micro-channel reactor, the second micro-channel reactor and the back-pressure device being sequentially connected; and the method comprising:
(1) simultaneously feeding a solution of an alkylamine compound of formula (I) in a first solvent and a solution of an acid-binding agent in a second solvent to a first micro-mixer for mixing followed by pre-reaction in the first micro-channel reactor to obtain a pre-reaction solution;
(2) simultaneously feeding the pre-reaction solution and a solution of a phosphate of formula (II) or a phosphite of formula (III) in a third solvent to the second micro-mixer for mixing to obtain a first reaction mixture;
(3) feeding the first reaction mixture to the second micro-channel reactor to carry out a condensation reaction under a back pressure condition set by the back pressure device to obtain a second reaction mixture;
(4) collecting the second reaction mixture by a storage tank for concentration to obtain an alkyl phosphate ester compound of formula (IV) or formula (V); 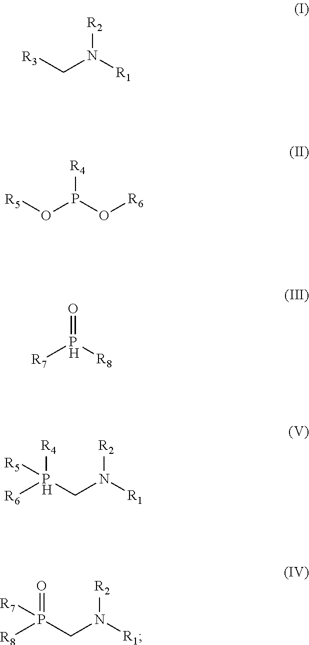
wherein R1 is selected from the group consisting of hydrogen, a C₁-C₁₂ alkyl, —COOH, —CH₂COOH, and a C₂-C₁₂ alkylcarboxylic acid; R₂ is selected from the group consisting of hydrogen, a C₁-C₁₂ alkyl, and a C₃-C₆ cycloalkyl; R₃ is selected from the group consisting of hydrogen, —OCH₃, —OCH₂CH₃, a C₂-C₁₂ alkoxy, trifluoromethyl, trifluoromethoxy, and 2-oxocyclopentylidenemethylidene; R₄ is selected from the group consisting of hydrogen, carbonyl, a C₁-C₁₂ alkyl, and a C₃-C₆ cycloalkyl; R₅ and R₆ are each selected from the group consisting of hydrogen, a C₁-C₁₂ alkyl, a C₃-C₆ cycloalkyl, and a C₂-C₁₂ alkoxy; and R₇ and R₈ are each selected from the group consisting of hydrogen, —OCH₃, —OCH₂CH₃, a C₂-C₁₂ alkoxy, trifluoromethyl, trifluoromethoxy, and 2-oxocyclopentylidene.

2. The method of claim 1, wherein the acid-binding agent is selected from the group consisting of triethylamine, tributylamine, trimethylamine, diisopropylethylamine (DIPEA), lithium formate, sodium formate, potassium formate, ammonium formate, R₂COOLi, R₂COONa, R₂COOK, R₂COONH₄, pyridine, and 2,6-dimethylpyridine; and
the first solvent is the same as the second solvent, and is selected from pentanol, butanol, isobutanol, tert-butanol, propanol, isopropanol, ethanol, methanol, methyl tert-butyl ether, tetrahydrofuran, 2-methyltetrahydrofuran, acetone, butanone, and methyl isobutyl ketone.

3. The method of claim 1, wherein the acid-binding agent is selected from the group consisting of triethylamine, trimethylamine, tributylamine, diethylamine, DIPEA, p-dimethylaminopyridine, pyridine, N, N-diisopropylethylamine, and a combination thereof.

4. The method of claim 1, wherein the pre-reaction in the first micro-channel reactor is performed at 30-60° C. for 2-15 min; and the condensation reaction in the second micro-channel reactor is performed at 40-100° C. for 5-20 min.

5. The method of claim 1, wherein a back pressure of the back pressure device is 10-100 bar.

6. The method of claim 1, wherein the first micro-mixer and second micro-mixer are each selected from a T-type micro-mixer, a Y-type micro-mixer, a Z-type micro-mixer, an X-type micro-mixer, a SK-type micro-mixer, a SX-type micro-mixer, a SV-type micro-mixer, and a serpentine plate-type micro-mixer.

7. The method of claim 6, wherein the serpentine plate type micro-mixer is provided with a channel; a serpentine pipeline is provided in the channel; angular projections are staggeredly provided in the serpentine pipeline; one end of the serpentine pipeline is provided with a feeding port, and the other end of the serpentine pipeline is provided with a discharging port; a circulating liquid channel is provided between an outer side of the serpentine pipeline and a wall of the channel; and one end of the circulating liquid channel is provided with a circulating liquid outlet, and the other end of the circulating liquid channel is provided with a circulating liquid inlet.

8. The method of claim 6, wherein the first micro-mixer and the second micro-mixer are each provided with an inlet, an outlet and a mixing chamber; a diameter of the inlet and the outlet is 1.0 mm-6.0 mm; a diameter of the mixing chamber is 1.0 mm-20 mm; and a height of the mixing chamber is 1.0 mm-40 mm.

9. The method of claim 1, wherein the first micro-channel reactor and the second micro-channel reactor are each a tubular micro-channel reactor with a water droplet configuration; the tubular micro-channel reactor is provided with a microchannel arranged in a plurality of S-shaped rows; water droplet components are uniformly provided on an inner wall of the microchannel; one end of the microchannel is provided with a feeding port, and the other end of the microchannel is provided with a discharging port; an outer layer of the microchannel is configured as a circulating liquid channel for circulation a circulating liquid; and one end of the circulating liquid channel is provided with a circulating liquid outlet, and the other end of the circulating liquid channel is provided with a circulating liquid inlet.

10. The method of claim 7, wherein an inner diameter of the microchannel is 0.1-50 mm, and a length of the microchannel is 10-100 m.
